(19) United States
(12) Patent Application Publication
(10) Pub. No.: US 2014/0238963 A1
(43) Pub. Date: Aug. 28, 2014

(54) APPARATUS FOR MANUFACTURING MASK AND METHOD OF MANUFACTURING MASK USING LASER BEAM

(71) Applicant: Samsung Display Co., Ltd., Yongin-City (KR)

(72) Inventors: Jun Ho JO, Seoul (KR); Doh-Hyoung LEE, Guri-si (KR)

(73) Assignee: Samsung Display Co., Ltd., Yongin-City (KR)

(21) Appl. No.: 14/021,420

(22) Filed: Sep. 9, 2013

(30) Foreign Application Priority Data
Feb. 22, 2013 (KR) 10-2013-0019226

(51) Int. Cl. B23K 26/067; B23K 26/30; B23K 26/12

(52) U.S. Cl. CPC B23K 26/067; B23K 26/127; B23K 26/423
USPC 219/121.77; 219/121.84; 219/121.68

(57) ABSTRACT

A mask manufacturing apparatus includes a chamber, a laser beam irradiator, a stage, a cooling system, and a fan. The chamber provides an interior space therein. At least an upper wall of the chamber comprises a glass. The laser beam irradiator is disposed outside the chamber and configured to divide a laser beam into a plurality of sub-laser beams to irradiate the sub-laser beams onto a shadow mask material. The stage is disposed in the chamber and the shadow mask material is placed on the stage. The cooling system is configured cool the interior space. The fan configured to discharge heat generated in the interior space of the chamber to the outside of the chamber. Therefore, the shadow mask may be protected from overheating.

### CROSS-REFERENCE TO RELATED APPLICATION

This U.S. non-provisional patent application claims priority under 35 U.S.C. §119 of Korean Patent Application No. 10-2013-0019226, filed on Feb. 22, 2013, the contents of which are hereby incorporated by reference in its entirety.

### BACKGROUND

1. Field of Disclosure

The present disclosure relates to an apparatus of manufacturing a mask and a method of manufacturing the mask using a laser beam.

2. Discussion of the Related Technology

In general, a deposition process is performed to deposit an organic material on a substrate using a shadow mask when an organic light emitting display device is manufactured. The shadow mask includes a specific pattern, and thus the organic material is deposited only in an area except for an area covered by the shadow mask.

The shadow mask is manufactured by using a wet etching process or a laser beam process. In the case of the wet etching process, the pattern is difficult to be exquisitely formed due to non-uniformity of the etching process. The shadow mask can be manufactured using the laser beam process or laser ablation process.

### SUMMARY

The present disclosure provides an apparatus of manufacturing a mask, which is capable of effectively discharging heat generated when a pattern is formed on a shadow mask using a laser beam.

The present disclosure provides a method of manufacturing the mask using a laser beam to effectively discharge or dissipate heat generated from the shadow mask.

Embodiments of the inventive concept provide a mask manufacturing apparatus including a chamber, a laser beam irradiator, a stage, a cooling system or cooler, and a fan.

The chamber provides an interior space therein. At least an upper wall of the chamber includes a glass.

The laser beam irradiator is disposed outside the chamber. The laser beam irradiator includes a laser generator, a diffractive optical element (DOE) lens, an optical system, and a scanner. The laser generator generates the laser beam. The DOE lens divides the laser beam into the sub-laser beams. The optical system reduces an aberration between the sub-laser beams. The scanner condenses or concentrates the sub-laser beams to irradiate the sub-laser beams onto the shadow mask material.

The stage is disposed in the chamber and the shadow mask material is placed on the stage.

The cooling system includes an air conditioner to cool the interior space.

The fan discharges a heat generated in the space to the outside of the chamber.

Embodiments of the inventive concept provide a mask manufacturing apparatus including a chamber, a laser beam irradiator, a stage, and a coolant passage.

The coolant passage is formed in the stage and a coolant flows through the coolant passage.

Embodiments of the inventive concept provide a method of manufacturing a mask including placing a shadow mask material in a chamber, irradiating sub-laser beams into the chamber from outside the chamber onto the shadow mask material to form a pattern thereon, and cooling heat generated from the shadow mask material.

According to the above, the shadow mask may be protected from overheating. As a result, the intensity of the sub-laser beams irradiated onto the shadow mask may be increased, and thus a time required to form the pattern on the shadow mask may be shortened.

In addition, the shadow mask may be protected from overheating by the mask manufacturing method.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a perspective view showing a mask manufacturing apparatus according to an exemplary embodiment of the present disclosure;

FIG. 2 is a block diagram showing a laser beam irradiator shown in FIG. 1;

FIG. 3 is a front view showing an inside of a chamber shown in FIG. 1;

FIG. 4 is a view showing a processing area of a shadow mask shown in FIG. 1;

FIG. 5 is a view showing an inside of a chamber according to another exemplary embodiment of the present disclosure;

FIG. 6 is a plan view showing a stage shown in FIG. 5; and

FIG. 7 is a flowchart showing a method of manufacturing a mask using a laser beam according to an exemplary embodiment of the present disclosure.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

When the shadow mask is manufactured using the laser beam process, heat is generated from an object onto which the laser beam is irradiated. In this case, the heat generated from the edge of the object is dissipated to surroundings of the object, but the heat generated from the center of the object is not easily dissipated. Accordingly, an overheating may occur in the center of the object, and the overheating causes defects, e.g., thermal deformation of the object.

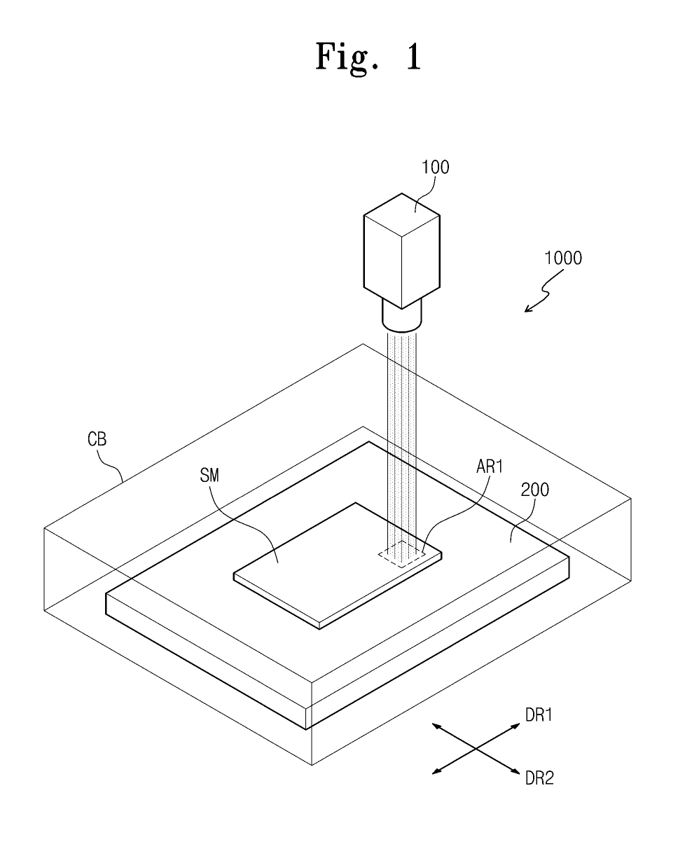

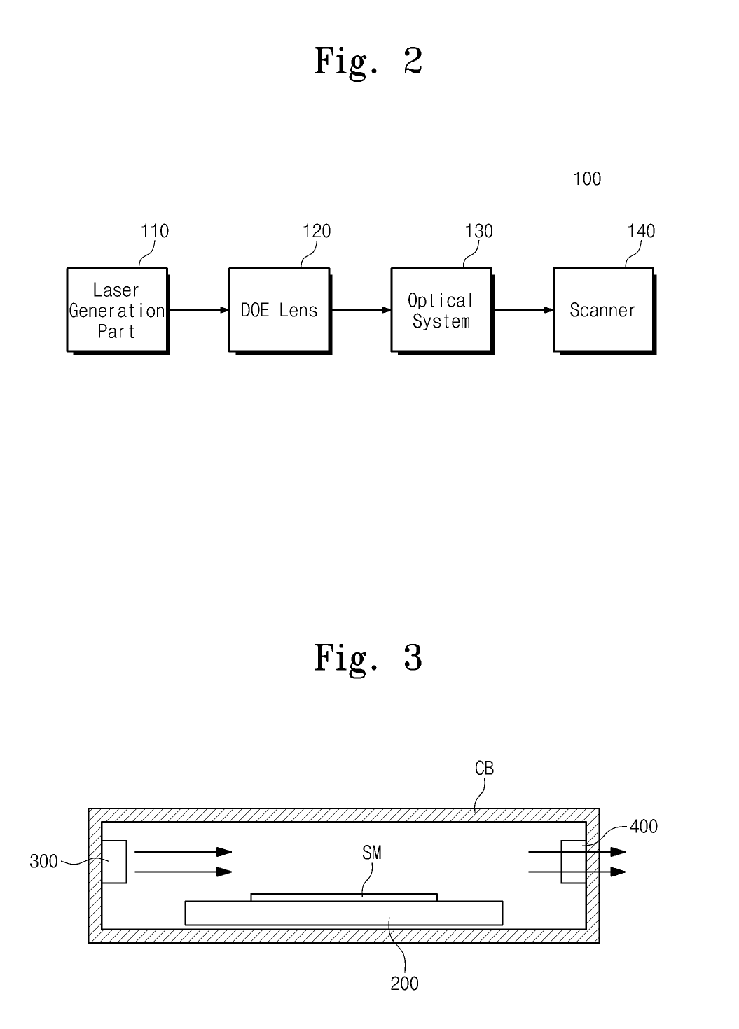

FIG. 1 is a perspective view showing a mask manufacturing apparatus 1000 according to an exemplary embodiment of the present disclosure, FIG. 2 is a block diagram showing a laser beam irradiator shown in FIG. 1, and FIG. 3 is a front view showing an inside of a chamber shown in FIG. 1.

Referring to FIGS. 1 to 3, the mask manufacturing apparatus 1000 includes a chamber CB, a laser beam irradiator 100, a stage 200, a cooling part or cooler 300, and a fan 400.

The chamber CB provides a space therein. The chamber CB may have various shapes, but the chamber CB having a rectangular column shape will be described as a representative example.

The space in the chamber CB is sealed, but it should not be limited thereto or thereby. In alternative embodiments, air in the chamber CB may be discharged to outside of the chamber CB by the fan 400.

At least a portion of an upper wall of the chamber CB is formed of glass. The laser beam irradiator 100 may be disposed above the upper wall of the chamber CB. Accordingly, a laser beam irradiated from the outside of the chamber CB may be provided to the inside of the chamber CB.

The laser beam irradiator 100 includes a laser generator 110, a diffractive optical element (DOE) lens 120, an optical system 130, and a scanner 140.

The laser generation part or laser beam generator 110 generates the laser beam with a predetermined intensity and a predetermined diameter.

The DOE lens 120 divides the laser beam emitted from the laser generator 110 into a plurality of sub-laser beams. The DOE lens 120 includes a diffractive optical element to divide the laser beam into the sub-laser beams using a diffraction phenomerion of the laser beam. The sub-laser beams are formed in an N-by-M array configuration (each of “N” and “M” is a natural number).

The optical system 130 reduces an aberration between the sub-laser beams to improve a field curvature. The sub-laser beams passing through the optical system 130 are focused on a shadow mask SM that is flat.

The scanner 140 condenses or concentrates the sub-laser beams to allow the sub-laser beams to be vertically irradiated onto a processing area ARI of the shadow mask SM. The scanner 140 downwardly irradiates the sub-laser beams. The scanner 140 may include a focusing lens, an f-theta lens, or an f-theta telecentric lens. In addition, the scanner 140 may be a galvano scanner.

The sub-laser beams emitted from the scanner 140 are irradiated onto the shadow mask SM after passing through the upper wall of the chamber CB. This is because the chamber CB is formed of the glass window. In some embodiments, at least a portion of the upper wall of the chamber is substantially transparent such that the laser beams can pass therethrough. In other words, the upper wall may include a transparent portion through which the sub-laser beams can pass. In other words, the sub-laser beams are irradiated onto the shadow mask SM after passing through the transparent portion of the upper wall of the chamber CB.

The stage 200 is disposed in the chamber CB. The shadow mask SM is placed on the stage 200. Although not shown in the figures, the stage 200 is movable and moves to first and second directions DR1 and DR2 to align the shadow mask SM, so that the sub-laser beams are irradiated onto the processing area ARI of the shadow mask SM.

In the present exemplary embodiment, the shadow mask SM may be made of an alloy containing iron and nickel, i.e., Invar. The shadow mask SM is patterned by the sub-laser beams and serves as a shadow mask to deposit an organic material during the making process of an organic light emitting device. The shadow mask SM has a thickness equal to or smaller than about 100 micrometers to improve a precision degree thereof.

The cooling part or cooler 300 is disposed on one side surface inside the chamber CB. The cooling part 300 cools the air in the chamber CB and allows the cooled air to travel to the other one side surface inside the chamber CB. The cooling part 300 may be, but not limited to, an air conditioner.

The fan 400 is disposed on the other one side surface inside the chamber CB to face the cooling part 300. The fan 400 can serve a portion of the side wall of the chamber CB. The fan 400 discharges the heat generated in the inner space of the chamber CB to the outside of the chamber CB.

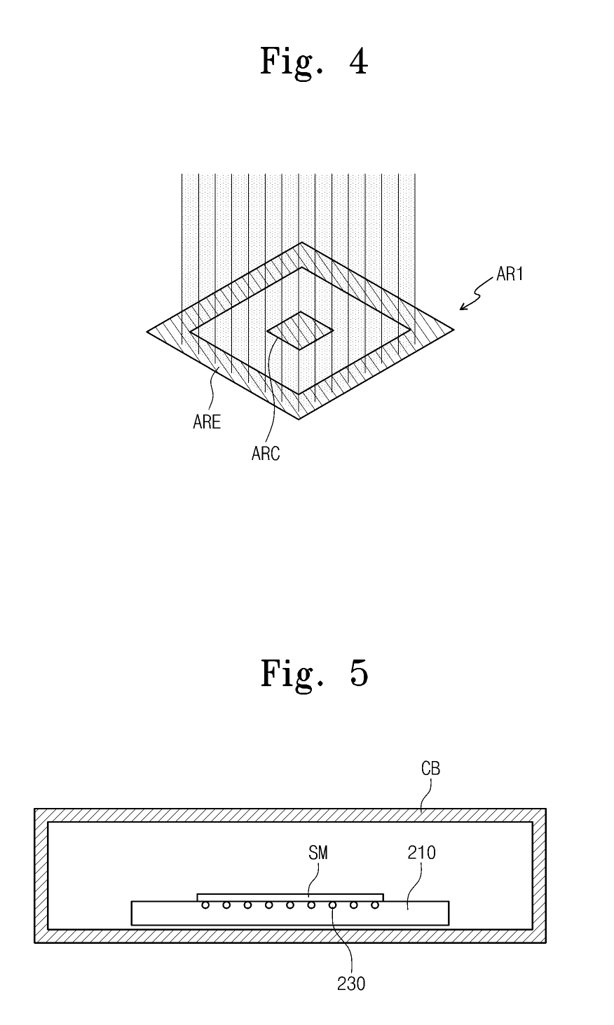

FIG. 4 is a view showing the processing area ARI of the shadow mask SM shown in FIG. 1.

Referring to FIGS. 3 and 4, when the sub-laser beams are irradiated onto the processing area AR1, the heat is generated by the sub-laser beams during a laser ablation process. In this case, the heat generated from an edge ARE of the processing area AR1 is discharged to the surroundings of the shadow mask SM, but the heat generated from a center ARC of the processing area ARI is hard to be discharged or dissipated to the surroundings of the shadow mask SM.

According to the mask manufacturing apparatus 1000, the shadow mask SM is processed in the chamber CB and the air of the inner space in the chamber CB is cooled by the cooling part 300 and the fan 400. Therefore, the heat generated when the shadow mask SM is processed may be effectively cooled. In addition, since the inner space of the chamber CB is sealed, a pressure in the chamber CB is easily controlled and the inner space of the chamber CB is filled with a desired gas. Further, external particles are not infiltrated into the chamber CB, and defects caused by the external particles may be prevented or minimized.

According to the mask manufacturing apparatus 1000, the shadow mask may be protected from overheating. As a result, the intensity of the sub-laser beams irradiated onto the shadow mask SM may be enhanced, and thus a time required to form the pattern on the shadow mask may be shortened.

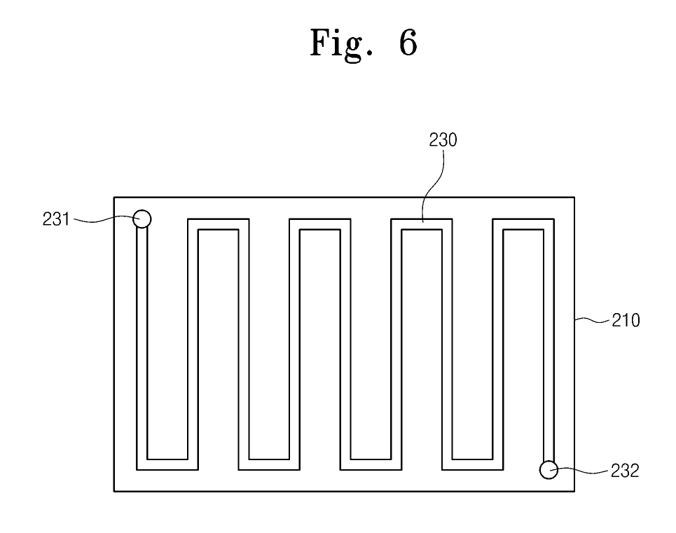

FIG. 5 is a view showing an inside of a chamber CB according to another exemplary embodiment of the present disclosure and FIG. 6 is a plan view showing a stage 210 shown in FIG. 5.

The chamber CB and the stage 210 shown in FIGS. 5 and 6 further include a cooling line or coolant passage 230 and do not include the cooling part and the fan which are shown in FIG. 3. Hereinafter, different parts in the chamber CB and the stage 210 from those of the chamber CB and the stage 200 shown in FIGS. 1 and 3 will be mainly described.

The mask manufacturing apparatus further includes the cooling line or coolant passage 230.

The cooling line 230 is formed in or inserted into the stage 210 and a coolant flows through the cooling line 230. In the present exemplary embodiment, the coolant may be one of chilly air, helium (He), process cooling water (PCW), Galden, air, and an N₂ gas.

Although not shown in figures, the stage 210 includes a receiving recess formed therein to accommodate the cooling line 230, and the cooling line 230 is inserted into the receiving recess. In the present exemplary embodiment, the cooling line 230 has a hollow pipe shape, but the cooling line 230 should not be limited to the hollow pipe shape.

Meanwhile, FIG. 6 shows one cooling line 230, but it should not be limited thereto or thereby. That is, the cooling line 230 may be provided in a plural number.

The mask manufacturing apparatus 231 further includes an inlet portion 231 and an outlet portion 232.

The inlet portion 231 is connected to one end of the cooling line 230, and the coolant is supplied to the cooling line 230 through the inlet portion 231.

The outlet portion 232 is connected to the other one end of the cooling line 230, and the coolant is drained through the outlet portion 232.

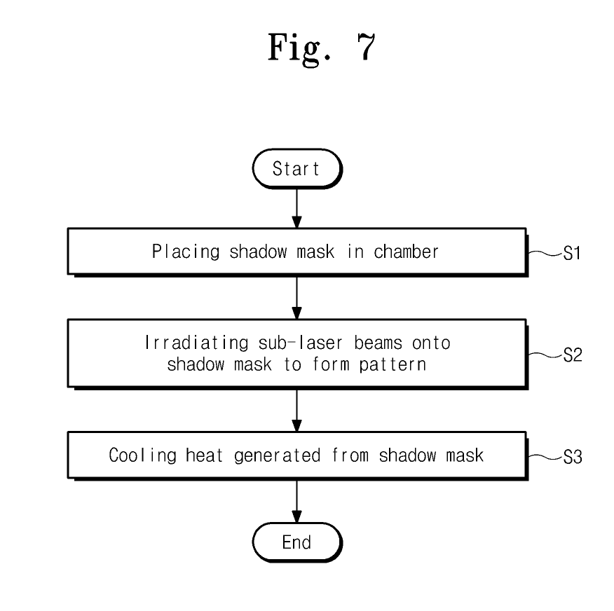

FIG. 7 is a flowchart showing a method of manufacturing a mask using a laser beam according to an exemplary embodiment of the present disclosure.

Referring to FIG. 7, the shadow mask material, to be processed, is disposed in the chamber (S1). In the illustrated embodiments, the shadow mask material is disposed on the stage, but it should not be limited thereto or thereby. That is, the shadow mask is fixed to the stage using separate frames or clamping units. Meanwhile, at least a portion of the upper wall of the chamber is formed of the glass. In some embodiments, at least a portion of the upper wall of the chamber is substantially transparent such that the laser beams can pass therethrough.

Then, the sub-laser beams are irradiated onto the shadow mask material from the outside of the chamber to form the pattern on the shadow mask (S2). To this end, the laser beam is divided into the sub-laser beams using the DOE lens. The sub-laser beams irradiated reach onto the shadow mask after passing through the glass window of the upper wall of the chamber.

During the laser ablation heat is generated from the shadow mask and cooled (S3). The heat generated from the shadow mask may be cooled by the following two methods.

First, referring to FIG. 3, the air of the inner space of the chamber CB may be cooled using the cooling part 300 and the fan 400. The cooling part 300 may be the air conditioner.

Second, referring to FIGS. 5 and 6, the heat generated from the shadow mask SM may be directly cooled using the cooling line 230. The cooling line 230 is inserted into the stage 210, and the coolant flows through the cooling line 230.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A mask manufacturing apparatus comprising:
a chamber comprising an interior space therein;
a stage disposed in the chamber, on which a shadow mask material is to be placed;
a laser beam irradiator disposed outside the chamber and configured to divide a laser beam into a plurality of sub-laser beams to irradiate the sub-laser beams toward the stage such that the sub-laser beams are irradiated to a shadow mask material which is to be placed over the stage; and
a cooling system configured to cool the interior space.

2. The mask manufacturing apparatus of claim 1, wherein at least an upper wall of the chamber comprises a glass.

3. The mask manufacturing apparatus of claim 2, wherein the laser beam irradiator comprises:
a laser beam generator configured to generate a laser beam;
a diffractive optical element (DOE) lens configured to divide the laser beam into the sub-laser beams; and
a scanner configured to concentrate the sub-laser beams and further configured to irradiate the sub-laser beams.

4. The mask manufacturing apparatus of claim 3, wherein the laser beam irradiator further comprises an optical system configured to reduce an aberration between the sub-laser beams.

5. The mask manufacturing apparatus of claim 1, wherein the cooling system comprises an air conditioner.

6. The mask manufacturing apparatus of claim 1, further comprising a fan configured to discharge a heat generated in the interior space to the outside of the chamber.

7. The mask manufacturing apparatus of claim 6, wherein the cooling system is disposed on one side surface inside the chamber.

8. The mask manufacturing apparatus of claim 7, wherein the fan is disposed on the other one side surface inside the chamber.

9. The mask manufacturing apparatus of claim 1, wherein the laser beam irradiator is disposed on an upper wall of the chamber to downwardly irradiate the sub-laser beams.

10. A mask manufacturing apparatus comprising:
a chamber comprising an interior space therein;
a stage disposed in the chamber, on which a shadow mask material is to be placed;
a laser beam irradiator disposed outside the chamber and configured to divide a laser beam into a plurality of sub-laser beams to irradiate the sub-laser beams toward the stage such that the sub-laser beams are irradiated to a shadow mask material which is to be placed over the stage; and
a coolant passage formed in the stage such that a coolant flows therethrough.

11. The mask manufacturing apparatus of claim 10, further comprising:
an inlet connected to a first end of the coolant passage; and
an outlet connected to a second end of the coolant passage.

12. The mask manufacturing apparatus of claim 10, wherein at least an upper wall of the chamber comprises a glass.

13. A method of manufacturing a mask, comprising:
placing a shadow mask material in a chamber;
irradiating sub-laser beams into the chamber from outside the chamber onto the shadow mask material to form a pattern thereon; and
cooling heat generated from the shadow mask.

14. The method of claim 13, wherein irradiating the sub-laser beams comprises:
dividing a laser beam into the sub-laser beams; and
irradiating the sub-laser beams through an upper wall of the chamber onto the shadow mask material.

15. The method of claim 13, wherein at least an upper wall of the chamber comprises a glass.

16. The method of claim 13, wherein the cooling of the heat generated from the shadow mask comprises cooling an air in the chamber.

17. The method of claim 16, wherein the air in the chamber is cooled using an air conditioner.

18. The method of claim 13, wherein the cooling of the heat generated from the shadow mask comprises flowing a coolant through a coolant passage formed in a stage on which the shadow mask material is placed.
